(19) United States
(12) Patent Application Publication
(10) Pub. No.: US 2009/0185651 A1
(43) Pub. Date: Jul. 23, 2009

(54) CONTROL ROD POSITION DETECTOR AND CONTROL ROD DRIVE MECHANISM

(76) Inventors: Hirokazu Akatsuka, Hitach-shi (JP); Toshihiro Kodama, Hitachi-shi (JP)

Correspondence Address: BRUNDIDGE & STANGER, P.C., 1700 DIAGONAL ROAD, SUITE 330, ALEXANDRIA, VA, 22314, US

(21) Appl. No.: 12/356,766

(22) Filed: Jan. 21, 2009

(30) Foreign Application Priority Data
Jan. 23, 2008 (JP) 2008-012460

(51) Int. Cl. G21C 17/00

(52) U.S. Cl. 376/258

(57) ABSTRACT

A control rod position detector for detecting position of a control rod being linked to a control rod drive mechanism, comprising:
a first rotational axis rotated by a motor in the control rod drive mechanism;
a gear mechanism engaging with the first rotational axis; and
first and second position detectors attached to a second rotational axis of the second gear mechanism and outputting position signals of the control rod by rotation of the second rotational axis.

### CLAIM OF PRIORITY

The present application claims priority from Japanese Patent application serial no. 2008-012460, filed on Jan. 23, 2008, the content of which is hereby incorporated by reference into this application.

### BACKGROUND OF THE INVENTION

The present invention relates to a control rod position detector and a control rod drive mechanism, and, more particularly, to a control rod position detector and a control rod drive mechanism preferably applied to a boiling water reactor (hereinafter referred to as BWR).

In general, a reactor pressure vessel (hereinafter referred to as RPV) of a BWR is filled with a coolant that doubles as a moderator. A core in which a plurality of fuel assemblies are loaded is disposed in the RPV. Control rods (CR) to be inserted among fuel assemblies are disposed in the RPV. Controls of reactor control for a start-up, shutdown, compensation of reactivity, load following and the like of the nuclear reactor are performed by withdrawing the control rods from the core and inserting the control rods into the core. The control rod is linked with a control rod drive mechanism (hereinafter referred to as CRD) provided at the bottom of the RPV and moved by the CRD in an axial direction of the RPV.

An exemplary CRD is shown in FIG. 21 in Japanese Patent Laid-open No. 2007-40728. The CRD has an outer tube in which a guide tube is provided. A ballnut, and a hollow piston which is attached to it and lengthens upward are disposed in the guide tube. The upper end portion of the hollow piston is linked to the control rod. A ball screw provided in the hollow piston engages the ballnut. The ball screw is linked to the rotational axis of a motor, and thereby rotated by the motor. The ballnut moves upward and downward by the rotation of the ball screw, and the hollow piston moves upward and downward accordingly. The control rod is then inserted into or withdrawn from the core, controlling the reactor power.

The CRD has a control rod position detector for detecting a position of the control rod in the axial direction of the core. The control rod position detector outputs information about the rotation of the rotational axis of the motor in the form of electric signals. The control rod position detector has two position detectors for duplication. The two position detectors are rotated by different gear mechanisms, which engage with the rotational axis of the motor of the CRD, and detect the position of the control rod. Each gear mechanism has a gear string comprising a plurality of mutually engaged gears.

The reason why a combination of the position detector and gear mechanism is duplicated in the CRD is to assure reliable position detection; even if one of the two position detector fails, the other position detector reliably detects the position of the control rod. Japanese Patent Laid-open No. 2001-221879 and Japanese Patent Laid-open No. Hei 8 (1996)-21891 disclose CRDs having a plurality of position detectors.

### SUMMARY OF THE INVENTION

It has been clarified after studies by the inventors that the above CRD in which the combination of the position detector and gear mechanism is duplicated has the problems described below. In a conventional CRD, different gear mechanisms engage individually with different position detectors. Since the gears included in the gear string of each gear mechanism are manufactured with different precisions, there are differences in positions with which the gears are attached. Accordingly, there is a difference between two measured values of the control rod position measured by the two position detectors. If a difference between the two measured values of the control rod position output from the two position detectors is large, it becomes difficult to determine which of the two measured values is correct. To eliminate the difference between the measured values of the two position detectors and fix the range of variations in detection precision, it is necessary to increase machining precision and attachment precision for the gears of the two gear mechanisms.

Another problem is that the duplicated gear mechanisms require many parts, resulting in a high probability of the gears and bearings suffering damage and scoring.

An object of the present invention is to provide a control rod position detector and a control rod drive mechanism that have a simplified structure and can increase detection precision of control rod position.

A feature of the present invention for attaining the above object is a control rod position detector comprising a first rotational axis rotated by a motor in a control rod drive mechanism, a gear mechanism engaging with the first rotational axis, a second rotational axis attached to the gear mechanism, and first and second position detectors attached to the second rotational axis and outputting control rod position signals based on rotation of the second rotational axis.

Since the first and second position detectors are attached to the second rotational axis, which is a single rotational axis, just one gear mechanism is needed, simplifying the structure of the control rod position detector. Since the first and second position detectors are attached to the same rotational axis, a difference in manufacturing precisions for the gears included in the gear mechanism and a difference in positions with which the gears are attached affect the control rod positions detected by the first and second position detectors to the same extent. Accordingly, a difference between the control rod position detected by the first position detector and the control rod position detected by the second position detector is lessened, further improving the detection precision for the control rod positions detected by the first and second position detectors.

According to the present invention, the structure of the control rod position detector can be simplified and control rod detection precision can be further increased

### BRIEF DESCRIPTION OF THE DRAWINGS

FIG. 1 is a longitudinal sectional view showing a control rod position detector according to a first embodiment which is a preferably embodiment of the present invention, being applied to a control rod drive mechanism used in a boiling water reactor.

FIG. 2 is a plane view showing the control rod position detector shown in FIG. 1.

FIG. 3 is a longitudinal sectional view showing a control rod drive mechanism according to a preferably embodiment of the present, to which the control rod position detector shown in FIG. 1 is applied.

FIG. 4 is a longitudinal sectional view showing a control rod position detector according to a second embodiment which is another embodiment of the present invention, being applied to a control rod drive mechanism used in a boiling water reactor.

FIG. 5 is a longitudinal sectional view showing a control rod position detector according to a third embodiment which is another embodiment of the present invention, being applied to a control rod drive mechanism used in a boiling water reactor.

### DETAILED DESCRIPTION OF THE PREFERRED EMBODIMENTS

Embodiments of the present invention will be described.

### First Embodiment

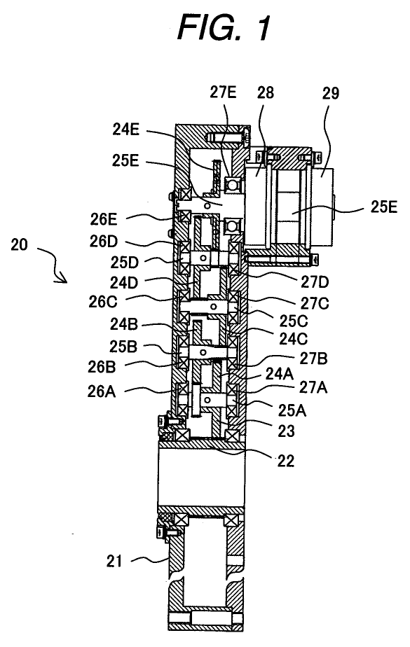

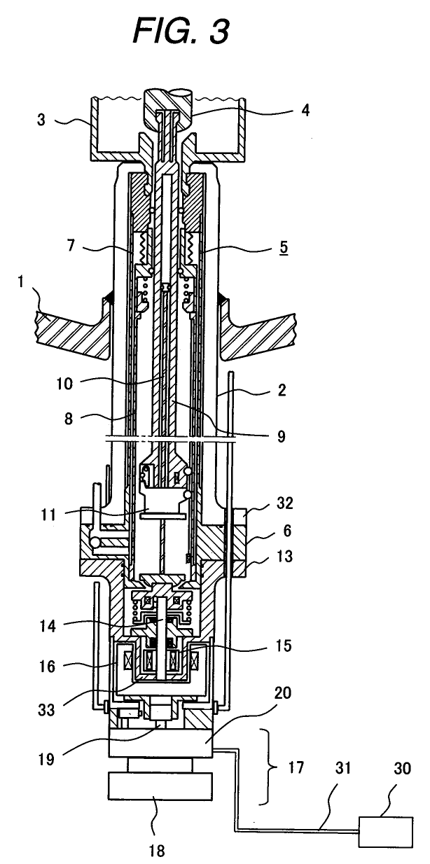

A control rod position detector being applied to a control rod drive mechanism (hereinafter referred to as the CRD) of a first embodiment which is a preferably embodiment of the present invention, will be described with reference to FIGS. 1 to 3. The CRD having the control rod position detector is applied will be described in detail with reference to FIG. 3. A boiling water reactor (BWR) to which a CRD 5 is applied has a reactor power vessel (hereinafter referred to as RPV) 1. The RPV 1 includes a control rod drive mechanism housing (hereinafter referred to as the CRD housing) 2, at the bottom, which extends downward. A control rod guide tube 3, which is provided in the RPV 1, is disposed on the top of the CRD housing 2. A control rod 4 is disposed in the control rod guide tube 3.

The CRD 5 has a control rod drive mechanism body (hereinafter referred to as the CRD body) 6, a spool piece 13 and a motor unit 17 (see FIG. 3). The CRD body 6 and spool piece 13 are attached to a flange 32 of the CRD housing 2. The motor unit 17 is attached to the spool piece 13. The CRD body 6 is disposed in the CRD housing 2, and the spool piece 13 and motor unit 17 are disposed outside the CRD housing 2.

The CRD body 6 includes an outer tube (casing) 7, a guide tube 8, a hollow piston (piston member) 9, a ball screw (ball screw member) 10 and a ballnut 11. The outer tube 7 is disposed in the CRD housing 2. The guide tube 8 is disposed in the outer tube 7. The ballnut 11 engages the ball screw 10. The hollow piston 9 is placed on the ballnut 11. A part that exists above the ballnut 11, of the ball screw 10 is disposed in the hollow piston 9. The control rod 4 disposed in the control rod guide tube 3 is attached to an upper end portion of the hollow piston 9 and is detachable from the upper end portion.

The spool piece 13 has a pressure bulkhead 33. The spool piece 13 includes a driving axis 14 and an inner magnet coupling 15 inside the pressure bulkhead 33 and also includes an outer magnet coupling 16 outside the pressure bulkhead 33. The driving axis 14 is connected to the inner magnet coupling 15 and also linked to the ball screw 10. The inner magnet coupling 15 and outer magnet coupling 16 are cylindrical and face each other with the pressure bulkhead 33 intervening therebetween. The outer magnet coupling 16 is connected to the driving axis 19. The inner magnet coupling 15 and outer magnet coupling 16 are magnetically coupled joints. The pressure bulkhead 33 has a function for sealing the bottom of the CRD housing 2.

The motor unit 17 has a motor 18, a driving axis 19 and a control rod position detector 20. The driving axis 19 is linked to the motor 18. The control rod position detector 20 is attached to the spool piece 13 and linked to the driving axis 19.

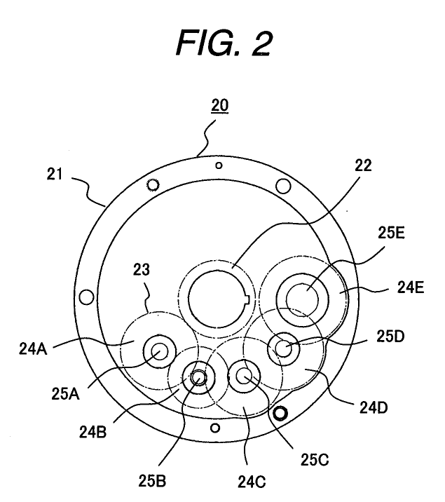

The control rod position detector 20 has a casing 21, an input axis 22, a gear mechanism (reducer) 23 and position detectors 28 and 29 (see FIG. 1). The gear mechanism 23 includes gears 24A to 24E and rotational axes 25A to 25E. The casing 21 is attached to the spool piece 13. The driving axis 19 is inserted into the input axis 22, which is ring-shaped, and fitted to the input axis 22. The gear mechanism 23, which has a plurality of gears, is disposed in the casing 21. The rotational axes 25A to 25E are disposed in the casing 21. Bearing 26A to 26E and 27A to 27E are provided in the casing 21. The gears 24A to 24E are separately attached to the rotational axes 25A to 25E by pins. Both end portions of the rotational axis 25A are supported by the bearings 26A and 27A. Both end portions of the rotational axis 25B are supported by the bearings 26B and 27B. Both end portions of the rotational axis 25C are supported by the bearings 26C and 27C. Both end portions of the rotational axis 25D are supported by the bearings 26D and 27D. Both end portions of the rotational axis 25E are supported by the bearings 26E and 27E. The gear 24A attached to the rotational axis 25A is engaged with a gear formed on the outer surface of the input axis 22. The gear 24B attached to the rotational axis 25B is engaged with a gear formed on the rotational axis 25A. The gear 24C attached to the rotational axis 25C is engaged with a gear formed on the rotational axis 25B. The gear 24D attached to the rotational axis 25D is engaged with a gear formed on the rotational axis 25C. The gear 24E attached to the rotational axis 25E is engaged with a gear formed on the rotational axis 25D. The gears 24A to 24E are disposed around the driving axis 19, that is, around the input axis 22 (see FIG. 2). The position detectors 28 and 29 are attached to the casing 21 and linked to the rotational axis 25E side by side. The control rod position detector 20 includes two position detectors, that is, the position detectors 28 and 29, to form a duplicated arrangement for detecting the position of the control rod 4. In this embodiment, the position detectors 28 and 29 are attached to a single rotational axis (rotational axis 25E) in two stages.

How the control rod 4 controls power of the nuclear reactor during a BWR operation will be described. The driving axis 19 rotates by the driving of the motor 18 and then the outer magnet coupling 16 rotates. The outer magnet coupling 16 and inner magnet coupling 15 each have a magnet. When the outer magnet coupling 16 rotates, the inner magnet coupling 15 also rotates by the magnetic force of these magnets. The rotation of the inner magnet coupling 15 is transmitted by the driving axis 14 to the ball screw 10. When the ball screw 10 rotates, the ballnut 11, which is engaged with the ball screw 10, lowers. A part of the ballnut 11 is inserted into a groove (not shown), which is formed in the internal surface of the guide tube 8 and extends in the axial direction. Therefore, even when the ball screw 10 rotates, the rotation of the ballnut 11 is impeded and the ballnut 11 moves in the axial direction of the CRD 5. When the ballnut 11 lowers, the control rod 4 is withdrawn from the core (not shown), increasing the reactor power.

When the motor 18 is rotated in the reverse direction, the driving axes 19 and 14 and the ball screw 10 rotates in the reverse direction, raising the ballnut 11. The control rod 4 is then inserted into the core, lowering the reactor power.

The rotation of the driving axis 19 is transmitted to the rotational axis 25A through the input axis 22, rotating the gear 24A. The rotation of the gear 24A is transmitted in turn to the gears 24B, 24C, 24D and 24E in that order, and thereby the rotational axis 25E rotates. Accordingly, the position detectors 28 and 29 concurrently detect the position of the control rod 4 disposed in the core and operated by the CRD 5. Position detection signals (electric signals) of the control rod 4, detected by the position detectors 28 and 29 are output to a controller 30 via a cable 31. The controller 30 receives the position detection signals and converts them into position information of the control rod 4 in the axial direction of the core, and outputs the position information to a display unit (not shown) provided on an operation panel in a central control room. The position information of the control rod 4 in the axial direction of the core is displayed on the display unit.

In this embodiment, only one gear mechanism 23 is used, and two position detectors 28 and 29 are attached to the rotational axis 25E of the gear mechanism 23, so the structure of the control rod position detector 20 can be simplified. In the arrangement in which the two position detectors 28 and 29 are attached to the rotational axis 25E of the one gear mechanism 23, the two position detectors 28 and 29 can rotate together by one rotational axis 25E, so the rotations of the position detectors 28 and 29 are placed in phase. Accordingly, a difference between the control rod position detected by the position detector 28 and the control rod position detected by the position detector 29 is lessened, improving the detection precision for the control rod positions detected by the position detectors 28 and 29. Rotational forces are transmitted to the position detectors 28 and 29 through one gear mechanism 23, so a difference in manufacturing precisions for the gears included in the gear mechanism 23 and a difference in positions with which the gears are attached affect the control rod positions detected by the position detectors 28 and 29 to the same extent. This also lessens the difference between the control rod position detected by the position detector 28 and the control rod position detected by the position detector 29, further improving the detection precision for the control rod positions detected by the position detectors 28 and 29. Since only one gear mechanism 23 is disposed and the gears for transmitting the rotational forces to the position detectors 28 and 29 are aligned as a single gear string, the number of parts in the control rod position detector 20 can be reduced. Accordingly, the probability of damaging the parts of the control rod position detector 20 is lowered and the reliability of the control rod position detector 20 can be increased.

In the control rod drive mechanism shown in FIG. 1 in Japanese Patent Laid-open No. 2001-221879, a reduction gear and two position detectors are disposed below a motor. The reduction gear is linked to the rotational axis of the motor, and the two position detectors are attached to the rotational axis of the reduction gear. By comparison, in the control rod drive mechanism of this embodiment, the control rod position detector 20 is disposed above the motor 18. So, the axial length of the control rod drive mechanism in this embodiment is shorter than that of the control rod drive mechanism described in Japanese Patent Laid-open No. 2001-2218792, making the control rod drive mechanism in this embodiment compact.

In the control rod position detector 20, the gears 24A to 24E included in one gear mechanism 23 are disposed around the circumference of the input axis 22, so the thickness in the axial direction can be reduced. The axial length of the CRD 5 can be reduced.

The control rod position detector 20 in the CRD 5 of this embodiment is simplified and has fewer parts, so the inertial force of the control rod position detector 20 can be reduced. Accordingly, the CRD 5 can quickly operate the control rod 4.

### Second Embodiment

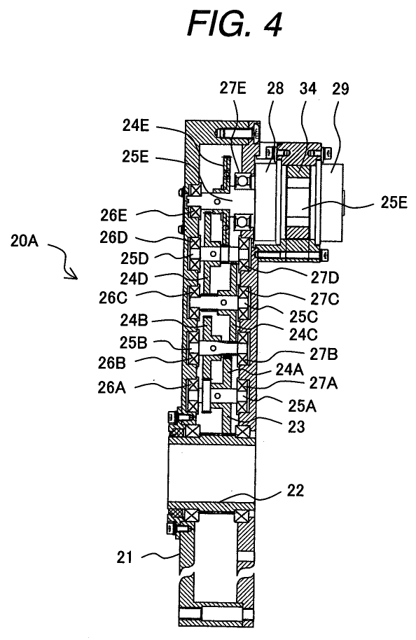

A control rod position detector of a CRD according to a second embodiment of the present invention will be described with reference to FIG. 4. The control rod position detector 20A of this embodiment is structured by adding a magnetic shield member 34 to the control rod position detector 20 of the first embodiment. The magnetic shield member 34 is disposed between the position detectors 28 and 29 and surrounds the rotational axis 25E. The gear 25E in this embodiment is made of a non-magnetic material.

The control rod position detector 20A in this embodiment can obtain the same effects as in the first embodiment. In this embodiment, as described above, the magnetic shield member 34 is disposed between the position detectors 28 and 29, so variations in electrical position signals due to mutual electrical influences caused by the position detectors 28 and 29, that is, electromagnetic induction, are reduced and thereby error due to these variations is also reduced. Since the variations caused by the above electromagnetic induction can be suppressed, electrical signals are stabilized, enabling the control rod position detector 20A to offer high performance. The rotational axis 25E made of a non-magnetic material further reduces the mutual electrical influences by the position detectors 28 and 29, enabling the control rod position detector 20A to offer further high performance.

The CRD 5 including the control rod position detector 20A can also obtain the effects produced by the CRD 5 in the first embodiment.

### Third Embodiment

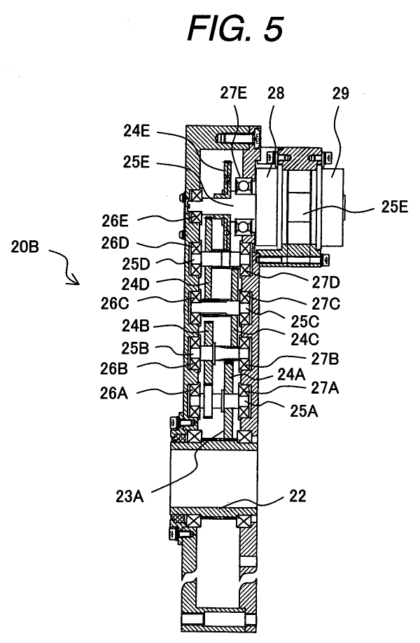

A control rod position detector in a CRD in a third embodiment of the present invention will be described with reference to FIG. 5. The control rod position detector 20B in this embodiment is structured by separately laser-welding the gears 24A to 24E in the control rod position detector 20 in the first embodiment to the corresponding rotational axes of the rotational axes 25A to 25E.

In this embodiment, since laser welding is performed, instead of using pins, to attach the gears 24A to 24E to the rotational axes 25A to 25E, bosses can be eliminated from the gears 24A to 24E. Accordingly, the rotational axes 25A to 25E can be shortened and thereby the control rod position detector 20B can be made thinner in the axial direction of the CRD 5 than the control rod position detector 20. The CRD 5 in this embodiment can be made shorter in its axial direction than in the first embodiment. This embodiment can also obtain the same effects as in the first embodiment.

What is claimed is:

1. A control rod position detector for detecting position of a control rod being linked to a control rod drive mechanism, comprising:
a first rotational axis rotated by a motor in the control rod drive mechanism;
a gear mechanism engaging with the first rotational axis; and
first and second position detectors attached to a second rotational axis of the second gear mechanism and outputting position signals of the control rod by rotation of the second rotational axis.

2. The control rod position detector according to claim 1, wherein the gear mechanism has a plurality of gears for slowing the rotation of the first rotational axis to obtain a slowed rotation and transmitting the slowed rotation to the second rotational axis.

3. The control rod position detector according to claim 2, wherein the plurality of gears are disposed along a circumference of the first rotational axis.

4. The control rod position detector according to claim 1, wherein a magnetic shield member is provided between the first position detector and the second position detector.

5. The control rod position detector according to claim 2, wherein a magnetic shield member is provided between the first position detector and the second position detector.

6. The control rod position detector according to claim 3, wherein a magnetic shield member is provided between the first position detector and the second position detector.

7. The control rod position detector according to claim 1, wherein the second rotational axis is made of a non-magnetic material.

8. The control rod position detector according to claim 2, wherein the second rotational axis is made of a non-magnetic material.

9. The control rod position detector according to claim 3, wherein the second rotational axis is made of a non-magnetic material.

10. The control rod position detector according to claim 4, wherein the second rotational axis is made of a non-magnetic material.

11. The control rod position detector according to claim 2, wherein each of the plurality of gears included in the gear mechanism is attached to a rotational axis to which the each of the plurality of gears by either a pin member or laser welding.

12. A control rod drive mechanism, comprising:
a casing;
a guide tube disposed in the casing;
a ball screw member disposed in the guide tube;
a ballnut engaging with the ball screw member;
a piston member placed on the ballnut and being linked to a control rod;
a motor for rotating the ball screw member; and
a control rod position detector;
wherein the control rod position detector has a first rotational axis rotated by the motor, a gear mechanism engaging with the first rotational axis, and first and second position detectors attached to a second rotational axis of the second gear mechanism and outputting position signals of the control rod by rotation of the second rotational axis.
